(19) United States
(12) Patent Application Publication
(10) Pub. No.: US 2007/0035947 A1
(43) Pub. Date: Feb. 15, 2007

(54) Illumination system and illumination module thereof

(76) Inventors: Hsiao-Yi Li, Taoyuan Hsien (TW); Hung-Lung Cheng, Taoyuan Hsien (TW); Kenny Huang, Taoyuan Hsien (TW); Mei-Luan Hsieh, Taoyuan Hsien (TW); Chia-Cheng Weng, Taoyuan Hsien (TW); Chih-Heng Huang, Taoyuan Hsien (TW)

Correspondence Address: Douglas J. Christensen;Patterson, Thuente, Skaar & Christensen, P.A., 4800 IDS Center, 80 South Eighth Street, Minneapolis, MN, 55402, US

(21) Appl. No.: 11/253,218

(22) Filed: Oct. 18, 2005

(30) Foreign Application Priority Data
Aug. 9, 2005 (TW) 094126999

(51) Int. Cl. B60Q 1/26

(52) U.S. Cl. 362/227

(57) ABSTRACT

An illumination module includes a plurality of LEDs and a control circuit, wherein each of the LEDs generates a beam in a unique color and the control circuit, electrically connected to the LEDs, periodically switches among the LEDs to illuminate at a switching rate and in a switching sequence in order to mix the beams to visually produce a light in a particular color. An illumination system includes a plurality of aforementioned illumination modules and a control circuit, electrically connected to the illumination modules. The control circuit periodically switches among the illumination modules to illuminate at a switching rate and in a switching sequence.

### CROSS-REFERENCES TO RELATED APPLICATIONS

This application claims priority to Taiwan Patent Application No. 094126999 filed on Aug. 9, 2005.

### BACKGROUND OF THE INVENTION

1. Field of the Invention

The present invention relates to an illumination system and an illumination module thereof and, in particular, relates to an illumination system using LEDs and an illumination module thereof.

2. Descriptions of the Related Art

Most LCDs of the prior art use a great number of illumination units to generate light spots to form a picture for display. Every illumination unit includes an LED configured to emit a beam in a particular color.

U.S. Pat. No. 6,536,914 discloses an illumination system used in an LCD. The illumination system includes a light-emitting panel having a light emission window and at least one edge surface for coupling lights into the light-emitting panel. The illumination system further includes a light mixing chamber placed next to the edge surface to provide a light source. The light source includes a plurality of clusters of LEDs having different light-emission wavelengths, e.g., a blue LED, a green LED, a red LED, or even an amber LED so a uniform light distribution can be provided.

Though the illumination system saves more power than traditional CRT monitors, each cluster of LEDs continues to illuminate when the LCD is powered on. Therefore a considerable amount of power is still consumed, especially when the illumination system is applied to either a middle or a large size LCD. Besides, the sustained illumination of LEDs causes the LCD overheated and, hence, affects its lifetime. Accordingly, an illumination module with low power consumption is critically needed in the industrial field.

### SUMMARY OF THE INVENTION

An object of the present invention is to provide an illumination module comprising a first LED, a second LED, a third LED and a control circuit. The first LED is configured to generate a first beam in a first color, the second LED is configured to generate a second beam in a second color, and the third LED is configured to generate a third beam in a third color. The control circuit, electrically connected to the first LED, the second LED, and the third LED, is configured to periodically switch among the first LED, the second LED, and the third LED to illuminate at a switching rate and in a switching sequence in order to mix the first beam, the second beam, and the third beam to visually produce a light in a particular color. Such an illumination module has advantages of power saving, low heating, and high efficiency of illumination.

The switching sequence may be: (1) the first LED illuminating; (2) the second LED illuminating; (3) the third LED illuminating; and (4) the first, the second, and the third LEDs illuminating simultaneously.

The illumination module may further comprise a fourth LED for generating a fourth beam in a fourth color. The first beam, the second beam, the third beam, and the fourth beam are mixed to visually produce the light in the particular color. The switching sequence may be: (1) the first LED illuminating; (2) the second LED illuminating; (3) the third LED illuminating; (4) the fourth LED illuminating; and (5) the first, the second, the third, and the fourth LEDs illuminating simultaneously.

Another object of the present invention is to provide an illumination system comprising a plurality of illumination modules and a control circuit. Each of the plurality of illumination modules comprises a first LED, a second LED, and a third LED. The first LED is configured to generate a first beam in a first color, the second LED is configured to generate a second beam in a second color, and the third LED is configured to generate a third beam in a third color, wherein the first beam, the second beam, and the third beam are mixed to visually produce a light in a particular color. The control circuit is electrically connected to the aforementioned plurality of illumination modules and is configured to periodically switch among the plurality of illumination modules to illuminate at a switching rate and in a switching sequence so that the illumination of the illumination system looks like that of a one-piece large light source. Such an illumination system has advantages of power saving, low heating, and uniform large size illumination.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a first embodiment of an illumination module in accordance with the present invention;

FIG. 2 illustrates a second embodiment of the illumination module in accordance with the present invention;

FIG. 3 illustrates a third embodiment of the illumination module in accordance with the present invention;

FIG. 4 illustrates another example of the third embodiment;

FIG. 5 illustrates another example of the third embodiment; and

FIG. 6 illustrates an embodiment of an illumination system in accordance with the present invention.

### DESCRIPTION OF THE PREFERRED EMBODIMENT

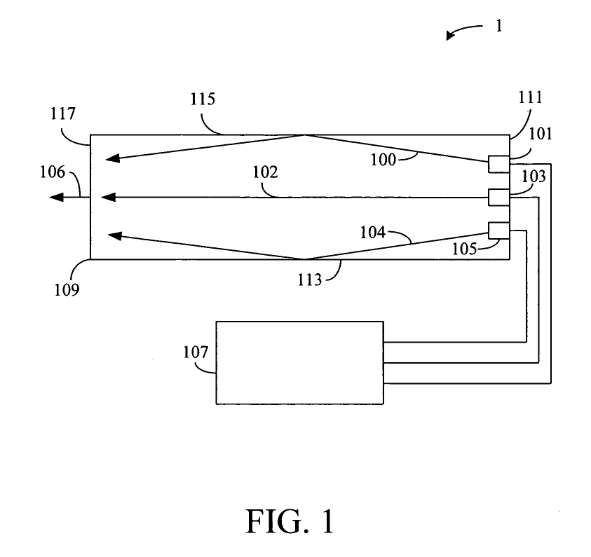

One embodiment of the present invention is an illumination module 1 adapted for a backlight module of an LCD as illustrated in FIG. 1. The backlight module includes an array consisting of a plurality of illumination modules 1. Each of the illumination modules 1 generates a light spot, i.e., a lighting pixel. These lighting pixels form a picture.

The illumination module 1 comprises a first LED 101 for generating a first beam 100 in a first color, a second LED 103 for generating a second beam 102 in a second color, a third LED 105 for generating a third beam 104 in a third color, and a control circuit 107. The control circuit 107, electrically connected to the first LED 101, the second LED 103 and the third LED 105, is configured to periodically switch among the first LED 101, the second LED 103, and the third LED 105 to illuminate at a certain switching rate and in a switching sequence.

The illumination module 1 further comprises a light guidance element 109. The first beam 100, the second beam 102, and the third beam 104 are mixed into a light 106 in a particular color visually in the light guidance element 109. The light guidance element 109 comprises a first side 111, a second side 113, a third side 115, and a fourth side 117. The first LED 101, the second LED 103, and the third LED 105 are placed on the first side 111. The second side 113 and the third side 115 are mirrors to reflect the first beam 100, the second beam 102, and the third beam 104, i.e., to reflect the light 106. The fourth side 117 of the illumination module 1 is a light outlet. The light 106 reflected by the second side 113 and the third side 15 emits out of the fourth side 117 to form the aforementioned light spot.

In this embodiment, the first color is red, the second color is green, and the third color is blue. The switching sequence controlled by the control circuit 107 is: (1) the first LED 101 illuminating; (2) the second LED 103 illuminating; (3) the third LED 105 illuminating; and (4) the first LED 101, the second LED 103, and the third LED 105 illuminating simultaneously. Since each LED is not illuminating all the time, power is saved. For example, during one switching period, the embodiment saves about 50% power in contrast to a backlight module without switching LEDs to illuminate. Moreover, because the illumination module 1 is made of semiconductor materials whose efficiency would decrease in a high temperature, switching each of the LEDs to illuminate can comparatively maintain a low temperature and, hence, maintain the high efficiency of semiconductor materials. Accordingly, this embodiment not only saves power but also has advantages of low heating and high efficiency of illumination.

If the light 106 in white is required to be generated by the illumination module 1, the first LED 101, the second LED 103, and the third LED 105 would generate the first beam 100, the second beam 102, and the third beam 104 with a proper saturation respectively so they can be mixed into a white light visually. If a switching rate is however too slow, i.e., not faster than the fastest rate at which human eyes can distinguish, the macroscopic colors of lights during the aforementioned switching sequence would be: (1) red; (2) green; (3) blue; and (4) white, but not white all the time. So the switching rate must be faster than the fastest rate at which human eyes can distinguish. More specifically, not slower than 1/120 of a second is preferred. In other words, if the switching rate is not slower than 1/120 of a second, the human eyes would see the light 106 in white continuously during a switching period.

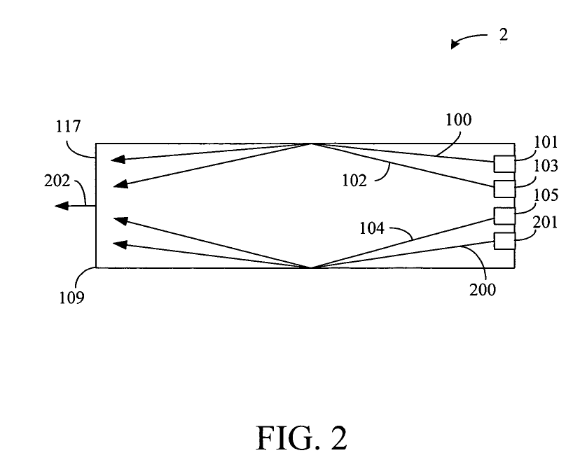

Generally speaking, a red beam, a green beam, and a blue beam can be mixed into a light in any color visually. But for current technologies, the brightness of a green LED or a blue LED is higher than that of a red LED. Such a brightness difference would result in a color deviation of a mixed light. To recover the insufficient brightness of red LEDs, another embodiment of the present invention is illustrated in FIG. 2. In contrast with the illumination module 1, an illumination module 2 (the control circuit 107 is not shown) further comprises a fourth LED 201 for generating a fourth beam 200 in a fourth color. The first beam 100, the second beam 102, the third beam 104, and the fourth beam 200 are visually mixed into a light 202 in a particular color. The fourth color is yellow to recover the insufficient brightness of the first LED 101.

In this embodiment, the switching sequence of the LEDs is: (1) the first LED 101 illuminating; (2) the second LED 103 illuminating; (3) the third LED 105 illuminating; (4) the fourth LED 201 illuminating; and (5) the first LED 101, the second LED 103, the third LED 105, the fourth LED 201 illuminating simultaneously. Similarly, since each LED is not illuminating all the time, power is saved. For example, during one switching period, the embodiment saves about 60% power in contrast to a backlight module without switching LEDs to illuminate. Besides, the embodiment also has the advantage of low heating as mentioned above.

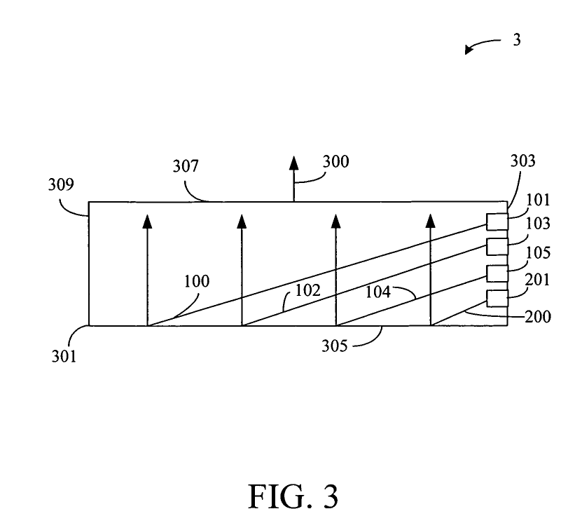

Though the light outlets of the aforementioned embodiments are both placed on the fourth side 117 of the light guidance element 109, the illumination module of the present invention may change the location of the light outlet based on actual needs. FIG. 3 shows another embodiment of the present invention which is also an illumination module. An illumination module 3 comprises a first LED 101, a second LED 103, a third LED 105, a fourth LED 201, and a control circuit (not illustrated). As mentioned above, the LEDs 101, 103, 105, and 201 are configured to generate a first beam 100 in a first color, a second beam 102 in a second color, a third beam 104 in a third color, and a fourth beam 200 in a fourth color respectively. They also can be mixed to visually produce a light 300 in a particular color.

The illumination module 3 also comprises a light guidance element 301, which comprises a first side 303, a second side 305, a third side 307, and a fourth side 309, wherein the LEDs 101,103, 105, and 201 are placed on the first side 303. What is different from the light guidance elements 109 of the illumination modules 1 and 2 is that the light outlet of the illumination module 3 is placed on the third side 307. Therefore, the light 300 in the light guidance element 301 is guided to the third side 307 for emitting.

In order to guide the light 300 to emit out of the third side 307, there are deformities (not illustrated) on the second side 305 of the light guidance element 301, which can be made by etching, scribing, or sandblasting. The deformities reflect the beams 100, 102, 104, and 200 emitting onto the second side 305 to the third side 307 of the light guidance element 301.

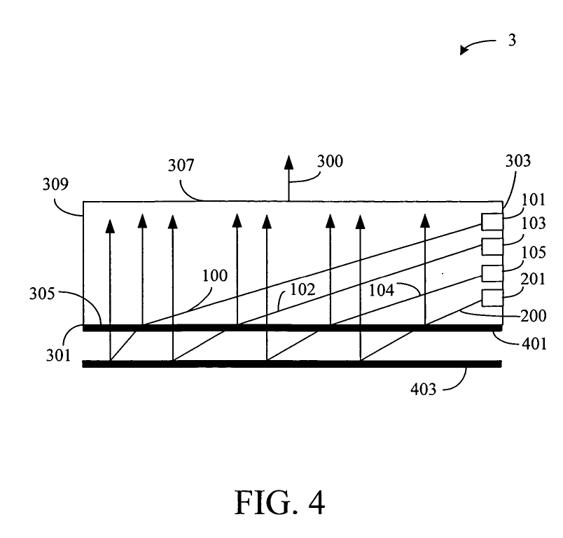

Other than using the deformities, the illumination module 3 may comprise a diffraction element 401 placed on the second side 305 of the light guidance element 301 as illustrated in FIG. 4. The diffraction element 401 reflects the first beam 100, the second beam 102, the third beam 104, and the fourth beam 200 to the third side 307.

Due to the material of the diffraction element 401, the diffraction element 401 might not be able to reflect the beams 100, 102, 104, and 200 to the third side 307 completely; this means a portion of the beams 100, 102, 104, and 200 would pass through the diffraction element 401. To increase the efficiency of reflection, the illumination module 3 may further comprise a reflection element 403 placed on another side, opposite the light guidance element 301, of the diffraction element 401, i.e., the reflection element 403 is placed under the diffraction element 401. The reflection element 403 can reflect the portion of the beams 100, 102, 104, and 200 refracted through the diffraction element 401 back to the third side 307 of the light guidance element 301. The diffraction element 401 may be a grating or made up of other elements with the function of diffraction.

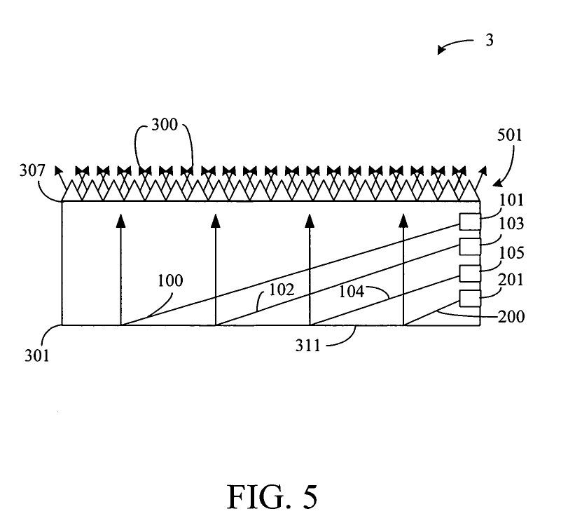

A prism array 501 may also be arranged on the third side 307 of the illumination module 3 as illustrated in FIG. 5 in order to control the angle of emergence of the light 300.

Though the light outlets of the aforementioned embodiments are simply on one side, either on the third side or the fourth side, the present invention does not limit the number of the light outlets. For example, the light outlets can be arranged on the third side as well as the fourth side so that there are two light outlets in one illumination module. Therefore, the present invention has an advantage of multiple light outlets on different sides to conform to the needs of practical use.

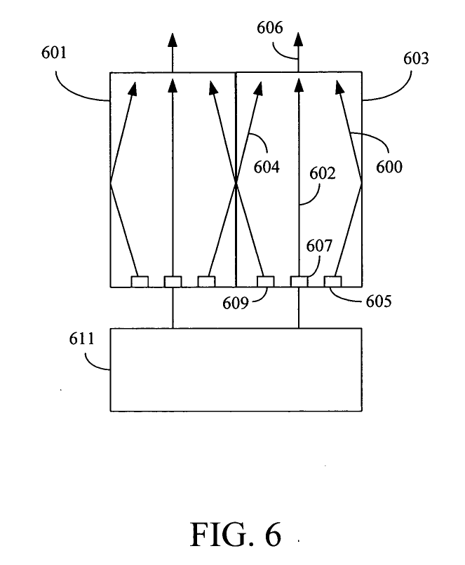

The present invention also provides an illumination system, an LCD, having a backlight module which comprises an array consisting of a plurality of illumination modules. Each of the illumination modules generates a lighting pixel. These lighting pixels form an array which shows a picture. One embodiment of the present invention is illustrated in FIG. 6. To simplify description, only two illumination modules 601 and 603 are illustrated. The illumination modules 601 and 603 comprise a first LED 605 for generating a first beam 600 in a first color, a second LED 607 for generating a second beam 602 in a second color, and a third LED 609 for generating a third beam 604 in a third color, respectively. The first beam 600, the second beam 602, and the third beam 604 are mixed into a light 606 in a particular color. The embodiment further comprises a control circuit 611, electrically connected to the illumination modules 601 and 603, configured to periodically switch between the illumination modules 601 and 603 to illuminate at a switching rate and in a switching sequence that caters to power saving and low heating. The illumination modules 601 and 603 may be the ones illustrated in FIG. 1 to FIG. 5.

If the switching rate is too slow, i.e., not faster than the fastest rate at which human eyes can distinguish, the human eyes could tell that the illumination modules emitting sequentially in a switching period but not a line light source or a plane light source formed by a plurality of point light sources generated by the illumination modules. Therefore, the switching rate must be faster than fastest rate at which human eyes can distinguish. It is preferred that the switching rate is not slower than 1/120 of a second. In other words, the slowest switching rate is 1/120 of a second.

Though the embodiment shown in FIG. 6 only shows two illumination modules, the people skilled in the art can easily analogize embodiments which have more than two illumination modules. For example, every 8 illumination module can be regarded as one unit in an LCD, and the illuminating sequence of every unit is controlled by one control circuit.

In practice, because the mold for producing an aforementioned illumination module is smaller than the mold for producing a large light source, the illumination system of this invention, a large light source which consists of many illumination modules, avoids the need of creating a large mold. Therefore, the cost is saved.

Though the above descriptions take LCDs as an example, the present invention does not limit the applications. People skilled in the art, for example, can apply the illumination module of the present invention to projectors, including front projectors and rear projectors, or other display apparatuses according to the disclosure above. Accordingly, the illumination system of the present invention may be a projector or other display apparatuses.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An illumination module, comprising:
a first LED for generating a first beam in a first color;
a second LED for generating a second beam in a second color;
a third LED for generating a third beam in a third color; and
a control circuit, electrically connected to the first LED, the second LED, and the third LED, for periodically switching among the first LED, the second LED, and the third LED to illuminate at a switching rate and in a switching sequence in order to mix the first beam, the second beam, and the third beam to visually produce a light in a particular color.

2. The illumination module as claimed in claim 1, wherein the switching rate is not slower than
$$\frac{1}{120}$$
of a second.

3. The illumination module as claimed in claim 1, wherein the switching sequence is:
(1) the first LED illuminating;
(2) the second LED illuminating;
(3) the third LED illuminating; and
(4) the first, the second, and the third LEDs illuminating simultaneously.

4. The illumination module as claimed in claim 1, wherein the first color is red, the second color is green, and the third color is blue.

5. The illumination module as claimed in claim 4, wherein the particular color is white.

6. The illumination module as claimed in claim 4, further comprising a fourth LED for generating a fourth beam in a fourth color, wherein the first beam, the second beam, the third beam, and the fourth beam are mixed to visually produce the light.

7. The illumination module as claimed in claim 6, wherein the fourth color is yellow.

8. The illumination module as claimed in claim 6, wherein the switching sequence is:
(1) the first LED illuminating;
(2) the second LED illuminating;
(3) the third LED illuminating;
(4) the fourth LED illuminating; and
(5) the first, the second, the third, and the fourth LEDs illuminating simultaneously.

9. The illumination module as claimed in claim 7, wherein the particular color is white.

10. The illumination module as claimed in claim 1, further comprising a light guidance element for guiding the light, wherein the light guidance element comprises a first side and the first LED, the second LED, and the third LED are placed on the first side.

11. The illumination module as claimed in claim 10, further comprising a diffraction element and a reflection element, the light guidance element further comprising a second side, wherein the diffraction element is placed on the second side and the reflection element is placed on another side, opposite to the light guidance element, of the diffraction element.

12. The illumination module as claimed in claim 10, wherein the light guidance element further comprises a second side with deformities.

13. The illumination module as claimed in claim 10, further comprising a prism array, wherein the light guidance element further comprises a third side and the prism array is placed on the third side.

14. An illumination system, comprising:
a plurality of illumination modules, each of the plurality of illumination modules comprising:
a first LED for generating a first beam in a first color;
a second LED for generating a second beam in a second color; and
a third LED for generating a third beam in a third color;
wherein the first beam, the second beam, and the third beam are mixed into a particular light visually; and
a control circuit, electrically connected to the plurality of illumination modules, for periodically switching among the plurality of illumination modules to illuminate at a switching rate and in a switching sequence.

15. The illumination system as claimed in claim 14, wherein the switching rate is not slower than
$$\frac{1}{120}$$
of a second.

16. The illumination system as claimed in claim 14, wherein the first color is red, the second color is green, and the third color is blue.

17. The illumination system as claimed in claim 16, wherein the particular color is white.

18. The illumination system as claimed in claim 16, wherein each of the plurality of illumination modules further comprises a fourth LED for generating a fourth beam in a fourth color, and the first beam, the second beam, the third beam, and the fourth beam are mixed to visually produce the light.

19. The illumination system as claimed in claim 18, wherein the fourth color is yellow.

20. The illumination system as claimed in claim 19, wherein the particular color is white.

21. The illumination system as claimed in claim 14, wherein each of the illumination modules further comprises a light guidance element for guiding the light, the light guidance element comprises a first side, and the first LED, the second LED, and the third LED are placed on the first side.

22. The illumination system as claimed in claim 21, wherein each of the illumination modules further comprises a diffraction element and a reflection element, the light guidance element further comprises a second side, the diffraction element is placed on the second side, and the reflection element is placed on another side, opposite to the light guidance element, of the diffraction element.

23. The illumination system as claimed in claim 21, wherein the light guidance element further comprises a second side with deformities.

24. The illumination system as claimed in claim 21, wherein each of the illumination modules further comprises a prism array, the light guidance element further comprises a third side, and the prism array is placed on the third side.

25. The illumination system as claimed in claim 14, wherein the illumination system is an LCD.

26. The illumination system as claimed in claim 14, wherein the illumination system is a projector.
